(19) United States
(12) Patent Application Publication
(10) Pub. No.: US 2021/0372868 A1
(43) Pub. Date: Dec. 2, 2021

(54) STRESS MANAGEMENT DEVICE

(71) Applicant: SHIMADZU CORPORATION, Kyoto (JP)

(72) Inventors: Yusuke YOKOI, Kyoto-shi (JP); Momoyo YAMAKAWA, Kyoto-shi (JP); Naoya FUJIWARA, Kyoto-shi (JP); Kenta ADACHI, Kyoto-shi (JP); Hiroaki TSUSHIMA, Kyoto-shi (JP); Tomoki SASAYAMA, Kyoto-shi (JP)

(21) Appl. No.: 17/322,088

(22) Filed: May 17, 2021

(30) Foreign Application Priority Data
May 26, 2020 (JP) 2020-091175

(51) Int. Cl. G01L 1/24; G06T 7/00; H04N 5/272; G06T 3/40; G06T 11/00

(52) U.S. Cl. CPC G01L 1/24; G06T 7/0002; G06T 11/001; G06T 3/40; H04N 5/272

(57) ABSTRACT

Provided is a stress measurement device capable of easily grasping the behavior of a stress generation site in a sample. The stress measurement device is provided with a camera for imaging light emitted by a stress luminescent material, a controller for processing an image captured by the camera, and a display for displaying the image processed by the controller. The controller detects the stress generation site according to a luminescence distribution of the stress luminescent material for each of the plurality of time-series images captured by the camera and controls the display such that each stress generation site detected for each of the plurality of images is displayed on one image in a superimposed manner in mutually different display modes.

### CROSS-REFERENCE TO RELATED APPLICATIONS

This application claims priority under 35 U.S.C. § 119 to Japanese Patent Application No. 2020-091175 filed on May 26, 2020, the entire disclosure of which is incorporated herein by reference in its entirety.

### BACKGROUND OF THE INVENTION

### Technical Field

The present disclosure relates to a stress measurement device.

### Description of Related Art

In a development side of a flexible device, the durability and the performance of a sample has been verified by repeatedly applying a load to the sample using a deformation test instrument. In the above-described test, when a defect is generated in a sample, a strain is generated in the periphery of the defect, and therefore there is a possibility that the sample breaks.

In recent years, as a technique for detecting such a defect, a technique using a stress luminescent material has been proposed. For example, Japanese Unexamined Patent Application Publication No. 2015-75477 (Patent Document 1) discloses a stress luminescence evaluation device for measuring the luminescence intensity of the stress luminescent material to evaluate it. In this stress luminescence evaluation device, a stress luminescent material is placed on a sample and an external force is applied to the stress luminescent material together with the sample to cause luminescence of the stress luminescent material. By imaging the luminescence of the stress luminescent material using the imaging device, the stress (strain) generated in the sample can be measured.

### PRIOR ART DOCUMENT

### Patent Document

Patent Document 1: Japanese Unexamined Patent Application Publication No. 2015-75477

### SUMMARY OF THE INVENTION

### Problems to be Solved by the Invention

By applying an external force to a sample on which a stress luminescent material is placed and observing a plurality of images sequentially captured by the imaging device, the behavior (temporal change in the position) of the stress generation site in the sample can be observed. However, it may take time and labor to observe a plurality of acquired images by displaying them one by one on a display in time series.

It is, therefore, an object of the present disclosure to provide a stress measurement device capable of easily grasping the behavior of a stress generation site in a sample.

### Means for Solving the Problem

A stress measurement device according to the present disclosure is a stress measurement device for measuring a stress occurring in a sample by detecting luminescence of a stress luminescent material arranged on a surface of the sample.

The stress measurement device includes:

an imaging device configured to image light emitted by the stress luminescent material;

a processor configured to process the image captured by the imaging device; and

a display configured to display the image processed by the processor.

wherein the processor is configured to:

detect a stress generation site according to a luminescence distribution of the stress luminescent material, for each of a plurality of time-series images captured by the imaging device; and

control the display such that each stress generation site detected for each of the plurality of images is displayed on one image in a superimposed manner in mutually different display modes.

### Effects of the Invention

According to this stress measurement device, since each stress generation site detected for each of a plurality of time-series captured images is displayed on one image in a superimposed manner in mutually different display modes, the behavior of the stress generation site in the sample can be easily grasped.

### BRIEF DESCRIPTION OF THE DRAWINGS

FIG. 1 is a block diagram showing an entire configuration of a stress measurement device according to Embodiment 1.

FIG. 2 is a diagram for explaining the operation of the load application mechanism shown in FIG. 1.

FIG. 3 is a block diagram functionally illustrating a configuration of a controller.

FIG. 4 is a flowchart for explaining the processing procedures of a stress measurement of a sample using the stress measurement device.

FIG. 5 is a timing chart for explaining the operations of a light source, a camera, and a holder in the stress measurement device.

FIG. 6 is a diagram for explaining a display method when displaying a measurement result of one measurement set on a display in the stress measurement device according to Embodiment 1.

FIG. 7 is a flowchart showing the details of procedures of the image processing and the image display processing executed in Steps S50 and Step S60 of FIG. 4.

FIG. 8 is a diagram for explaining a display method when displaying a measurement result of one measurement set on a display in a stress measurement device according to Modification 1.

FIG. 9 is a diagram for explaining a display method when displaying a measurement result of one measurement set on a display in a stress measurement device according to Modification 2.

FIG. 10 is a diagram for explaining a display method when displaying a measurement result of one measurement set on a display in a stress measurement device according to Embodiment 2.

FIG. 11 is a flowchart showing procedures of the image processing and the image displaying executed by the controller in Embodiment 2.

FIG. 12 is a diagram for explaining a display method when displaying a measurement result at a specified time for each measurement set on a display in a stress measurement device according to Embodiment 3.

FIG. 13 is a flowchart showing procedures of the image processing and the image displaying executed by the controller in Embodiment 3.

FIG. 14 is a flowchart showing procedures of the image processing and the image displaying executed by the controller in a modification of Embodiment 3.

### EMBODIMENTS FOR CARRYING OUT THE INVENTION

Hereinafter, some embodiments of the present disclosure will be described in detail with reference to the attached drawings. In the drawings, the same or corresponding portion is denoted by the same reference numeral, and the description thereof will not be repeated.

### Embodiment 1

### <Configuration of Stress Measurement Device>

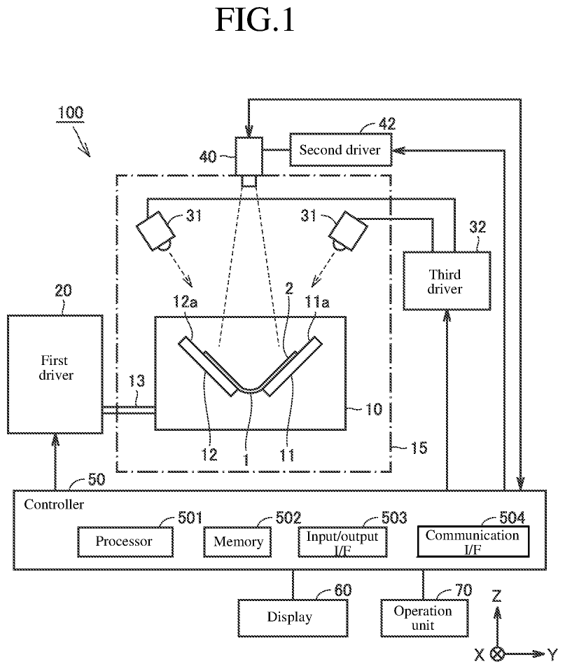

FIG. 1 is a block diagram showing the entire configuration of a stress measurement device according to Embodiment 1. Referring to FIG. 1, this stress measurement device 100 is a device that measures the stress (strain) generated in a test target 1 (hereinafter referred to as “sample 1”) by utilizing a luminescence phenomenon of a stress luminescent material. The stress measurement device 100 can also be used to test the durability to a stress generated in the sample 1.

The sample 1 has flexibility and is, for example, a flexible sheet or a flexible fiber. The flexible sheet may, for example, constitute a part of a flexible display or a wearable device of a communication terminal, such as, e.g., a smartphone and a tablet. The flexible fiber may constitute, for example, a part of an optical-fiber cable.

This Embodiment 1 exemplifies that the sample 1 is a flexible sheet of a rectangular shape. A stress luminescent material 2 is arranged on the sample 1. The stress luminescent material 2 is, for example, a stress luminescent sheet that contains a stress luminescent material and is arranged at least on a surface in a predetermined area of the sample 1. This predetermined area is set to include the area (deformation area of the flexible sheet) where a stress occurs when bending the flexible sheet. The stress luminescent material 2 is bent integrally with the sample 1 to generate strain.

The stress luminescent material 2 is a member that emits light by a mechanical stimulus from the outside, and a conventionally known member can be used. The stress luminescent material 2 has the property of emitting light by externally applied strain energy, and the luminescence intensity varies according to the strain energy. The stress luminescent material 2 is a solid solution of an element as a luminescence center in a crystal framework, and luminescence can be performed at various wavelengths from ultraviolet to visible to infrared by selecting an inorganic base material and an element as a luminescence center. Typical compositions include: defect-controlled strontium aluminate (SrAl₂O₄: Eu, green luminescence) to which europium is added as a luminescence center; zinc sulfide (ZnS: Mn, yellow-orange luminescence) to which manganese is added as a luminescence center; and structure-controlled barium calcium titanate ((Ba,Ca)TiO₃: Pr, luminous in red) to which praseodymium is added as a luminescence center.

The stress measurement device 100 is provided with a load application mechanism for applying a load to the sample 1. In the example of FIG. 1, the load application mechanism is configured to reproducibly reproduce a load applied to a flexible display when folding in a smartphone.

The load application mechanism has a holder 10 and a first driver 20. The holder 10 supports the sample 1 such that the surface of the sample 1 is positioned on the upper side (the upper side of the paper of FIG. 1). The first driver 20 is configured to bend the sample 1 by transitioning the holder 10 between a first position and a second position. For example, a deformation test device disclosed in Japanese Unexamined Patent Application Publication No. 2019-39743 can be applied to such a load application mechanism.

In the embodiment of FIG. 1, the holder 10 has a first mounting plate 11, a second mounting plate 12 and a drive shaft 13. The first mounting plate 11 has a rectangular main surface 11a. The second mounting plate 12 has a rectangular main surface 12a. The sample 1 is attached to the main surface 11a and the main surface 12a by bonding the back surface thereof.

The first driver 20 is attached to the base of the drive shaft 13. The drive shaft 13 is rotatably supported with its central axis parallel to the X-axis. The first driver 20 includes a motor, a transmission, and a controller (not shown) and rotates the drive shaft 13 forward and backward about its central axis by a predetermined rotation angle and rotation speed. Note that the rotation angle and the rotation speed of the drive shaft 13 are variable. Therefore, it is possible to appropriately change the bending angle and the bending speed in the bending test of the sample 1 to be described later.

The second mounting plate 12 is non-rotatably attached to the drive shaft 13. The second mounting plate 12 rotates in accordance with the rotation of the drive shaft 13. When the second mounting plate 12 rotates, the first mounting plate 11 also rotates.

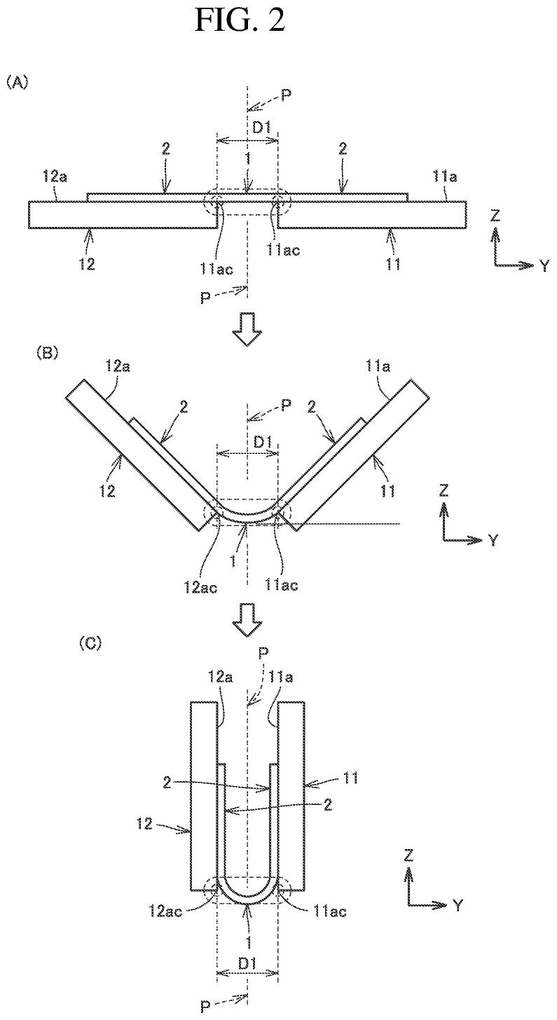

FIG. 2 is a diagram for explaining the operation of the load application mechanism shown in FIG. 1. FIG. 2 shows a view of the first mounting plate 11, the second mounting plate 12, and the sample 1 attached thereto as viewed from the X-axis direction. (B) of FIG. 2 and (C) of FIG. 2 show a state in which the sample 1 is folded from the state of (A) FIG. 2. The sample 1 has a stress luminescent material 2 placed on the surface of the sample 1.

Referring to FIG. 2, when the drive shaft 13 is rotated in the positive direction (clockwise direction) about its central axis by the first driver 20 from the state of (A) of FIG. 2, as shown in (B) and (C) of FIG. 2, the sample 1 attached to the main surface 12a and the main surface 11a is bent between the main surface 12a and the main surface 11a which are rotated in plane symmetrical to the P plane about the end portion 12ac and the end portion 12ac. The end portion 12ac and the end portion 12ac are arranged in parallel to each other, and the distance D1 therebetween is constant. Therefore, the sample 1 in the vicinity of the end portion 12ac, the vicinity of the end portion 11 ac, and between the end portions 11ac and 12ac is bent by substantially the same bending radius.

Further, the load application mechanism of FIG. 1 rotates the main surface 11a and main surface 12a about the end portion 12ac and the end portion 11ac in a state in which the end portion 12ac and the end portion 11ac are always in parallel to each other and the distance D1 therebetween is kept constant. Therefore, the portion of the sample 1 located between the vicinity of the end portion 12ac and the vicinity of the end portion 11 ac is deformed, but the remainder of the sample 1 is not substantially deformed.

Note that by rotating the drive shaft 13 in the opposite direction (counterclockwise direction) from the state in which the sample 1 is in a bent state ((C) of FIG. 2) by the first driver 20, the sample 1 returns to the state of (A) of FIG. 2 via the state of (B) of FIG. 2. Thus, by rotating the drive shaft 13 in the positive direction to change the state of the sample 1 from the state (the state in which the sample 1 is in a flat state) of (A) of FIG. 2 to the state (the state in which the sample is bent) of (C) of FIG. 2 (C) and then by rotating the drive shaft 13 in the opposite direction to return the state of the sample 1 from the state of (C) of FIG. 2 to the state of (A) of FIG. 2 (corresponding to one measurement set), the sample 1 is bent from a flat state and return to the flat state again. Therefore, it is possible to perform one bending test with respect to the sample 1. By alternately rotating the drive shaft 13 in the forward and reverse directions, the bending test of the sample 1 can be repeatedly performed.

Referring again to FIG. 1, the stress measurement device 100 is further provided with light sources 31, a housing 15, a camera 40, a second driver 42, a third driver 32, and a controller 50.

The light source 31 is arranged above the sample 1 and is configured to irradiate the stress luminescent material 2 with excitation light. Receiving the excitation light, the stress luminescent material 2 transitions to the light-emitting state. Preferably, the excitation light is light having a wavelength range of ultraviolet ray to blue light. As the excitation light, light in the wavelength of 10 nm to 600 nm (including from UV light to visible light) can be used. As the light source 31, a UV lamp, an LED (Light Emitting Diode), and the like can be used.

In the embodiment of FIG. 1, it is configured such that the excitation light is emitted from two directions to the stress luminescent material 2, but the light source 31 may be configured to emit excitation light to the stress luminescent material 2 from one direction or three or more directions.

The holder 10 and the light sources 31 are accommodated in a housing 15. In a state in which the light source 31 is in an off-state, the housing 15 can be made in a dark room.

The third driver 32 supplies power for driving the light source 31. The third driver 32 controls the light amount of the excitation light emitted from the light source 31, the irradiation time of the excitation light, etc., by controlling the power supplied to the light source 31 in response to the command received from the controller 50.

The camera 40 is arranged above the sample 1 such that the stress luminescent material 2 positioned on the predetermined area of the sample 1 is included in the field of view. In the example of FIG. 1, the camera 40 is attached to the ceiling surface of the housing 15. Specifically, the camera 40 is arranged such that the focusing position is positioned at at least one point in the predetermined area of the sample 1. Preferably, at least one point in the predetermined area is positioned at the bending center of the sample 1.

The camera 40 is an imaging device that includes an optical system, such as, e.g., a lens, and an imaging element. The imaging element is realized by, for example, a CCD (Charge Coupled Device) sensor, a CMOS (Complementary Metal Oxide Semiconductor) sensor, or the like. The imaging element generates a captured image by converting the light incident from the stress luminescent material 2 via the optical system into an electric signal.

The camera 40 is configured to sequentially image the luminescence of the stress luminescent material 2 located on the predetermined area at a predetermined frame rate at the time of the load application to the sample 1. The image data generated by the imaging by the camera 40 is transmitted to the controller 50.

The second driver 42 is configured such that the focusing position of the camera 40 can be changed in response to the command received from the controller 50. Specifically, the second driver 42 can adjust the focusing position of the camera 40 by moving the camera 40 along the Z-axis direction and the Y-axis direction shown in FIG. 1. For example, the second driver 42 has a motor for rotating the feed screw for moving the camera 40 in the Z-axis direction and the Y-axis direction and a motor driver for driving the motor. The feed screw is rotatably driven by the motor, whereby the camera 40 is positioned at a specified position within the predetermined range in the Z-axis and Y-axis directions. Further, the second driver 42 transmits the positional information indicating the position of the camera 40 to the controller 50.

The controller 50 controls the entire stress measurement device 100. The controller 50 has, as its main components, a processor 501, a memory 502, an I/O interface (I/F) 503, and a communication I/F 504. These units are communicatively connected to each other via a bus (not shown).

The processor 501 is typically an arithmetic processing unit, such as, e.g., a CPU (Central Processing Unit) and an MPU (Micro Processing Unit). The processor 501 controls the operation of each unit of the stress measurement device 100 by reading and executing a program stored in the memory 502. Specifically, the processor 501 executes a program, thereby realizing each of the processing of the stress measurement device 100, which will be described later. In FIG. 1, a configuration in which the processor is a single number is illustrated, but the controller 50 may be configured to include a plurality of processors.

The memory 502 is realized by a non-volatile memory, such as, e.g., a RAM (Random Access Memory), a ROM (Read Only Memory), and a flash memory. The memory 502 stores a program to be executed by the processor 501 or data to be used by the processor 501, and the like.

The input/output I/F 503 is an interface for exchanging various data between the processor 501 and the first driver 20, the third driver 32, the camera 40, and the second driver 42.

The communication I/F 504 is a communication interface for exchanging various data between the stress measurement device 100 and other devices and is realized by an adapter, a connector, or the like. Note that the communication method may be a wireless communication method using a wireless LAN (Local Area Network) or the like or a wired communication method using a USB (Universal Serial Bus) or the like.

The display 60 and the operation unit 70 are connected to the controller 50. The display 60 is configured by a liquid crystal panel or the like capable of displaying an image. The operation unit 70 accepts user's operational inputs to the stress measurement device 100. The operation unit 70 is typically configured by a touch panel, a keyboard, a mouse, and the like.

The controller 50 is communicatively connected to the first driver 20, the third driver 32, the camera 40, and the second driver 42. The communication between the controller 50 and the first driver 20, the third driver 32, the camera 40, and the second driver 42 may be realized by radio communication or wired communication.

### <Functional Configuration of Controller 50>

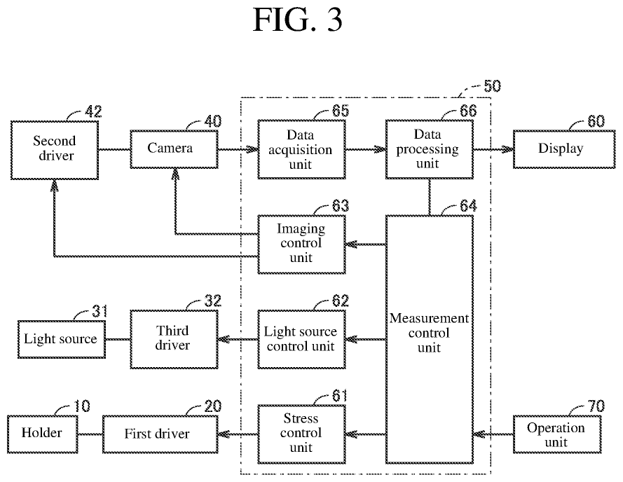

FIG. 3 is a block diagram functionally illustrating the configuration of the controller 50. Referring to FIG. 3, the controller 50 has a stress control unit 61, a light source control unit 62, an imaging control unit 63, a measurement control unit 64, a data acquisition unit 65, and a data processing unit 66. These are functional blocks realized based on the execution of a program stored in the memory 502 by the processor 501.

The stress control unit 61 controls the operation of the first driver 20. Specifically, the stress control unit 61 controls the operating speed and the operating time or the like of the first driver 20 according to the measurement condition set in advance. By controlling the operating speed and the operating time of the first driver 20, it is possible to adjust the rotation angle and the rotation speed of the drive shaft 13 in the holder 10. As a result, the bending angle, the bending speed, and the like of the sample 1 can be adjusted.

The light source control unit 62 controls the driving of the light source 31 by the third driver 32. More specifically, the light source control unit 62 generates a command for instructing the magnitude of the power supplied to the light source 31, the duration of the power supplied to the light source 31, and the like, based on a preset measurement condition, and outputs the generated command to the third driver 32. By controlling the electric power supplied to the light source 31 by the third driver 32 in accordance with the command, the amount of the excitation light irradiated from the light source 31, the irradiation time of the excitation light, and the like can be adjusted.

The imaging control unit 63 controls the moving of the camera 40 by the second driver 42. More specifically, the imaging control unit 63 generates a command for moving the camera 40 in accordance with the movement of the sample 1 in the predetermined area, based on the preset measurement condition and the positional information of the camera 40 input from the second driver 42. The imaging control unit 63 outputs the generated command to the second driver 42. By moving the camera 40 in accordance with the command by the second driver 42, the focusing position of the camera 40 can be maintained at at least one point of the predetermined area of the sample 1.

The imaging control unit 63 further controls imaging by the camera 40. Specifically, the imaging control unit 63 controls the camera 40 such that the sample 1 is imaged at least at the time of the load application, according to the measurement condition set in advance. The measurement condition for the imaging includes the frame rate of the camera 40.

The data acquisition unit 65 acquires the image data generated by the imaging by the camera 40 and transfers the acquired image data to the data processing unit 66.

By performing known image processing on the image data acquired by imaging by the camera 40 at the time of the load application, the data processing unit 66 measures the stress luminescence of the stress luminescent material 2. The data processing unit 66, for example, generates an image showing the distribution of the stress luminescence intensity in the stress luminescent material 2. The data processing unit 66 can display, on the display 60, the captured image by the camera 40 and the measurement result including an image showing the distribution of the stress luminescence intensity in the stress luminescent material 2 by the camera 40.

The measurement control unit 64 collectively controls the stress control unit 61, the light source control unit 62, the imaging control unit 63, the data acquisition unit 65, and the data processing unit 66. Specifically, the measurement control unit 64 gives a control command to each unit based on the information or the like of the measurement condition and the sample 1 input to the operation unit 70. <Stress Measurement Method>

Next, the stress measurement method of the sample 1 using the stress measurement device 100 will be described.

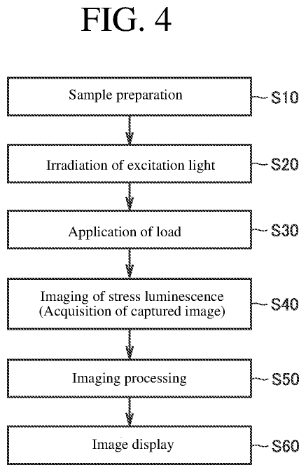

FIG. 4 is a flowchart for explaining the processing procedure of the stress measurement of the sample 1 using the stress measurement device 100.

Referring to FIG. 4, first, a sample 1 is prepared (Step S10). The sample 1 is attached to the main surface 11 a of the first mounting plate 11 and the main surface 12a of the second mounting plate 12 of the holder 10. When folding the sample 1 by the load application mechanism shown in FIG. 1, the deformation area is formed in the central portion of the sample 1 in the lateral direction (Y-direction). This deformation area has a strip-shape extending in the longitudinal direction (X-direction). The stress luminescent material 2 is adhered to the surface of the sample 1 so as to be positioned at least on the deformation area of the sample 1. For example, the stress luminescent material 2 has a rectangular shape of the same size as the sample 1 and is arranged so as to cover the entire surface of the sample 1.

The stress luminescent material 2 can be formed, for example, by bonding a stress luminescent sheet containing a stress luminescent material to a predetermined area of the sample 1. The stress luminescent material 2 is, for example, a defect-controlled strontium aluminate (SrAl₂O₄: Eu) with europium added and indicates green luminescence.

Next, the stress luminescent material 2 is irradiated with excitation light (e.g., UV rays) from the light source 31 (Step S20). The stress luminescent material 2 transitions to a light-emitting state upon receipt of the excitation light.

Next, by bending the sample 1 by driving the first driver 20, a load (bending load) is applied to the sample 1 (Step S30). As shown in FIG. 2, by rotating the drive shaft 13 in the positive direction by the first driver 20, the sample 1 is bent.

During which a load (bending load) is being applied to the sample 1, the camera 40 images the luminescence of the stress luminescent material 2 provided on the surface of the sample 1 (Step S40). Specifically, the camera 40 generates the number of still images corresponding to the frame rate during which the load (bending load) is being applied to the sample 1. The frame rate denotes a frame rate processed per unit time in the video processing. When the exposure time of the camera 40 is Te and the interval time from the exposure to the exposure of the next frame is Tr, the frame number m is expressed by m=Tm/(Te+Tr). Note that the imaging by the camera 40 is performed in a dark room.

Next, the controller 50 performs predetermined image processing on the image captured by the camera 40 (Step S50). Specifically, the controller 50 detects the stress generation site according to the luminescence distribution of the stress luminescent material 2 for each image of the number of images corresponding to the frame rate of the camera 40, which are generated in Step S40. In this Embodiment 1, an area where the luminescence intensity is higher than a threshold value is detected as the stress generation site.

Then, by observing the images processed in Step S50 in time series, it is possible to observe the behavior (spatial and temporal change) of the stress generation site during which a load (bending load) is being applied to the sample 1. However, it may take time and labor to display the acquired images one by one on the display 60 in chronological order and observe them.

Therefore, in the stress measurement device 100 according to Embodiment 1, the controller 50 makes the camera 40 display each stress generation site detected in Step S50 for each image captured in accordance with the frame rate of the camera 40 on the display 60 by superimposing them on one image in mutually different display modes (Step S60). With this, it becomes possible to easily grasp the behavior (spatial and temporal change) of the stress generation site in the sample 1 on one image. This will be described in detail later.

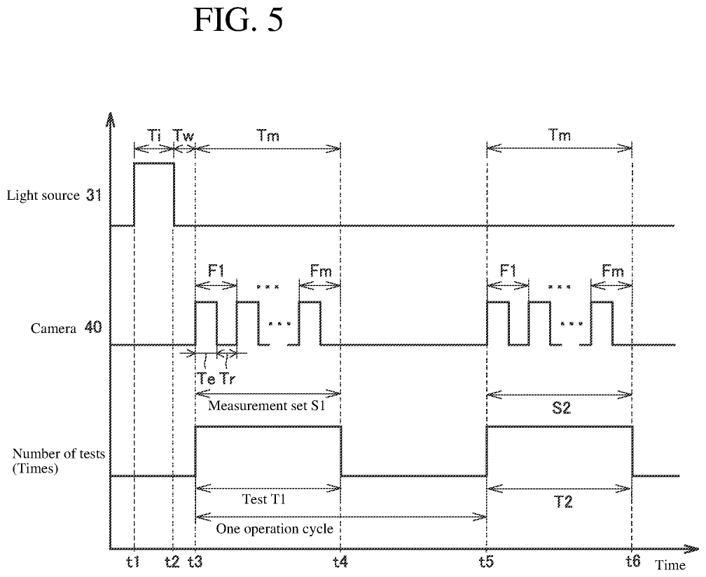

FIG. 5 is a timing chart for explaining the operations of the light source 31, the camera 40, and the holder 10 in the stress measurement device 100. In FIG. 5, a waveform showing the irradiation timing of the excitation light of the light source 31, a waveform showing the imaging timing of the camera 40, and a waveform showing the operation timing of the holder 10 by the first driver 20 are shown.

The operation timing of the holder 10 is shown by the “number of tests”. The operation of shifting the sample 1 from the flat state ((A) of FIG. 2) to the folded state ((C) of FIG. 2) is referred to as one bending test (hereinafter also referred to simply as “test”). Therefore, one test is performed in the first half of one operation cycle of the first driver 20. After one test, the sample 1 is returned to the flat state. In the example of FIG. 5, the test is repeated. The first test is also referred to as “T1” and the second test is also referred to as “T2”.

The stress measurement device 100 measures the luminescence of the stress luminescent material 2 placed in the predetermined area including at least the area where the sample 1 is folded, during the performance of the test. In FIG. 5, the test T1 is started at the time t3. During the time Ti from the time t1 prior to the time t3 to the time t2, excitation light is emitted from the light source 31 to the stress luminescent material 2. The time Tw from the time t2 to the time t3 corresponds to a standby time from the end of the excitation light emittance to the start of the measurement.

At the same time the test T1 is started at the time t3, imaging by the camera 40 is started. That is, the starting timing of the test T1 is made coincide with the imaging start timing by the camera 40. The imaging by the camera 40 is sequentially performed until the time t4 at which the test T1 is completed. That is, the test time Tm from the time t3 to the time t4 corresponds to the measurement time of the stress luminescence.

In the test time Tm (measurement time), the numbers of still images corresponding to the frame rate of the camera 40 are generated. When the exposure time of the camera 40 is Te and the interval time from the exposure to the next frame exposure is Tr, as described above, the frame number m is expressed as m=Tm/(Te+Tr).

In this disclosure, the set of m pieces of frames (still images) acquired by the camera 40 by the imaging of the camera 40 in one stress measurement processing is also referred to as “measurement set”. In FIG. 5, the measurement set acquired by the first stress measurement processing is also denoted as Si, and the measurement set acquired by the second stress measurement processing is also denoted to as S2. Each measurement set is configured by the frame Fl to the frame Fm.

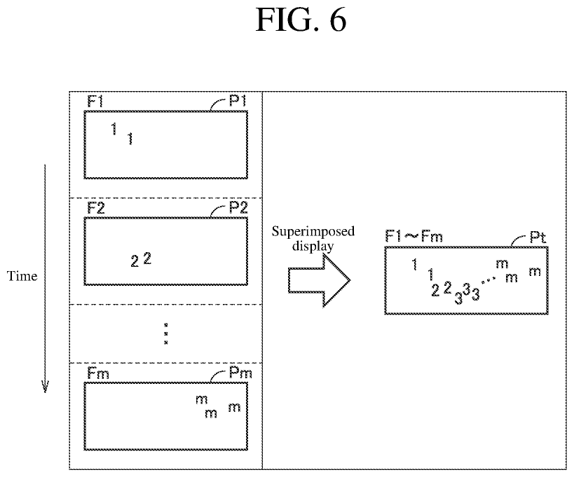

FIG. 6 is a diagram for explaining the display method when displaying the measurement result of one measurement set on the display 60, in the stress measurement device 100 according to Embodiment 1. Referring to FIG. 6, in one measurement set, m images of frames F1 to Fm are sequentially captured according to the frame rate of the camera 40.

The controller 50 detects the stress generation site according to the luminescence distribution of the stress luminescent material 2 in each of the frames Fl to Fm. In this Embodiment 1, an area where the luminescence intensity is higher than a threshold value is detected as the stress generation site.

The images P1 to Pm are images of stress generation sites detected at the frames Fl to Fm for a predetermined region-of-interest in the captured image (hereinafter referred to as “ROI (Region Of Interest)”) by the camera 40, respectively. The ROI may be the entire imaging area of the camera 40 or may be set by the user from the operation unit 70 (FIG. 1).

In this Embodiment 1, in each of the images P1 to Pm, the numeral character of the frame number corresponding to the detected stress generation site is arranged in the detected stress generation site. That is, the controller 50 detects the stress generation site in the set ROI for each frame Fi (i =1 to m) and arranges the numeric character “i” of the frame number in the detected stress generation site to thereby generate an image Pi indicating the stress generation site in the ROI. In this Embodiment 1, the size of the numeric character “i” to be displayed in the stress generation site is the same in each image Pi, and therefore, the larger the region of the stress generation site, the larger the number of the numeric character “i” to be displayed.

Then, in the stress measurement device 100 according to Embodiment 1, an image Pt acquired by superimposing the images P1 to Pm is displayed on the display 60. In the image Pt, the stress generation site corresponding to the frame Fi (i=1 to m) is displayed by the numeric character “i”. Therefore, the behavior (temporal change in the position) of the stress generation site in one measurement set can be easily grasped from one image Pt displayed on the display 60.

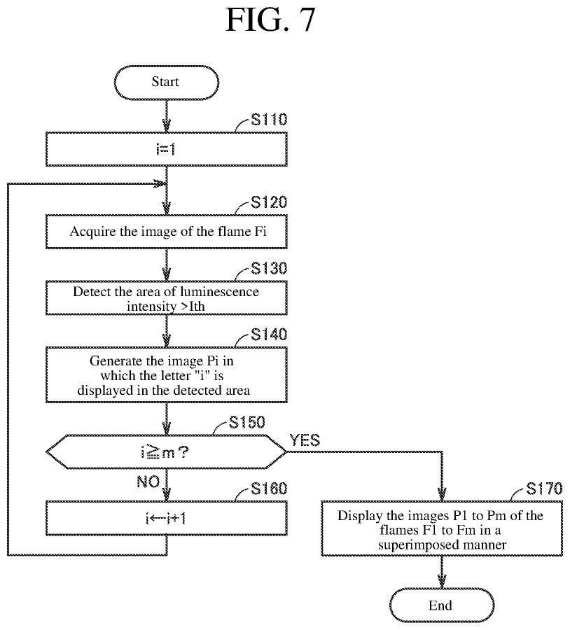

FIG. 7 is a flowchart showing the details of the procedures of the image processing and the image displaying executed in Steps S50 and S60 of FIG. 4. Referring to FIG. 7, the controller 50 first sets 1 to the variable i (Step S110) and acquires the image of the frame Fi (Step S120).

Next, the controller 50 detects an area (stress generation site) in which the luminescence intensity is higher than a threshold Ith in the set ROI in the acquired images (Step S130). The threshold Ith is appropriately set to the luminescence intensity level that requires the stress generation site observation. The ROI may be the entirety of the image to be captured or may be a region set by the user from the operation unit 70 (FIG. 1).

Then, the controller 50 arranges the numeric character “i” in the region (stress generation site) detected in Step S130 for the set ROI to thereby generate the image Pi indicating the stress generation site in the frame i (Step S140). That is, the area in the image Pi where the numeric character “i” is displayed indicates the stress generation site at the time when the frame Fi is imaged.

Next, the controller 50 determines whether or not the variable i is equal to or larger than the frame number m (Step S150). When the variable i is smaller than the frame number m (NO in Step S150), the controller 50 increments the variable i by 1 (Step S160) and returns the process to Step S120. That is, the processes of Steps S120 to S140 are repeatedly executed until the variable i reaches the frame number m.

When it is determined in Step S150 that the variable i has reached the frame number m (YES in Step S150), the controller 50 displays the image Pt acquired by superimposing the images P1 to Pm respectively corresponding to the frames F1 to Fm generated in Step S140 on the display 60 (Step S170).

As described above, in this Embodiment 1, the stress generation site is detected for the image (frames F1 to Fm) captured by the camera 40 in one stress measurement for the sample 1, and the detected stress generation sites are displayed in one image (image Pt) in a superimposed manner with mutually different symbols for each frame. In this Embodiment 1, as the symbol for displaying each stress generation site, the corresponding frame number is used. This makes it possible to easily grasp the behavior of the stress generation sites in one stress measurement to the sample 1.

Further, according to this Embodiment 1, since the area where the luminescence intensity of the stress luminescent material 2 exceeds the threshold Ith is detected as a stress generation site, it is possible to extract the stress generation sites worth to the verification and easily observe the behavior in one image.

Note that in the above-described description, as the symbol for displaying each stress generation site, the corresponding frame number is used, but a graphic symbol which differs for each frame may be used, instead of the frame number. In this instance, an index indicating the relation between the frame number of the elapse of the measurement time and the graphic symbol to be displayed is preferably displayed on the display 60 together with the image Pt.

### Modification 1

In Embodiment 1, in order to distinguish each stress generation site detected for each of the frames F1 to Fm from each other in the image Pt displayed on the display 60, the respective stress generation sites are displayed by symbols different from each other. Specifically, each stress generation site is displayed by the corresponding frame number.

In this Modification 1, in order to distinguish each stress generation site detected for each of the frames F1 to Fm, each stress generation site is displayed with different brightness. In this case, the stress generation sites are displayed such that the brightness of the stress generation site increases as the frame number increases. Even with such a display, the behavior of the stress generation sites can be easily grasped on one image.

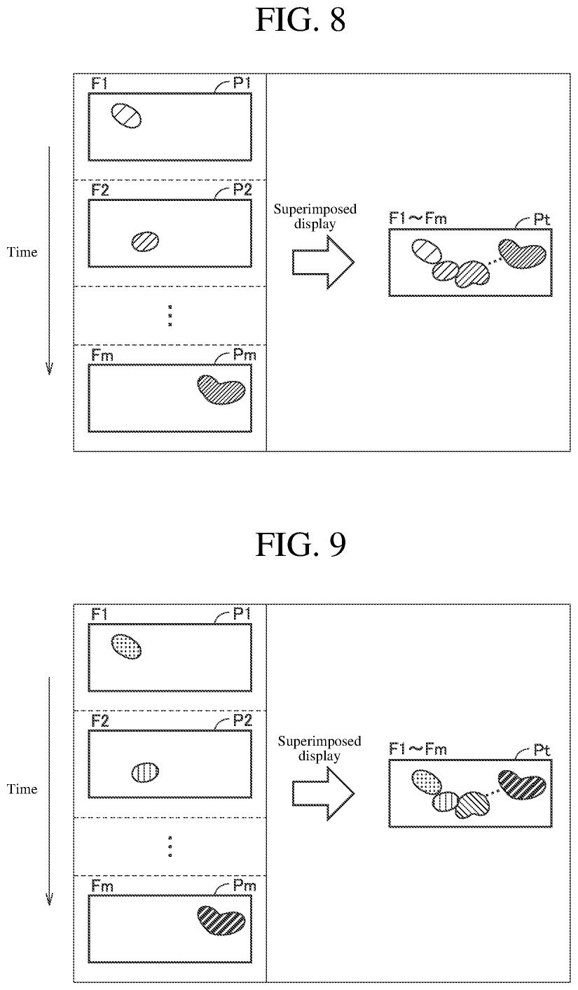

FIG. 8 is a diagram for explaining a display method when displaying the measurement result of one measurement set on the display 60 in the stress measurement device 100 according to Modification 1. FIG. 8 corresponds to FIG. 6 described in Embodiment 1.

Referring to FIG. 8, even in this Modification 1, the images P1 to Pm are images of the stress generation sites detected at the frames Fl to Fm, respectively, for a given ROI in the captured image by the camera 40.

In this Modification 1, the detected stress generation sites are displayed in the images P1 to Pm with different brightness. Specifically, in the images P1 to Pm, each stress generation site is displayed such that the brightness increases as the corresponding frame number increases. The controller 50 detects the stress generation site in the set ROI for each frame Fi (i =1 to m) and generates the image Pi indicating the stress generation site in the ROI with a predetermined brightness according to the frame number such that the brightness increases as the frame number increases.

Also in this Modification 1, the image Pt acquired by superimposing the images P1 to Pm is displayed on the display 60. In the image Pt, the stress generation site corresponding to the frame Fi (i=1 to m) is displayed with brightness predetermined according to the frame number such that the brightness increases as the frame number increases. Therefore, the behavior (temporal change in the position) of the stress generation site in one measurement set can be easily grasped from one image Pt displayed on the display 60.

Note that it is preferable that an index indicating the relation between the elapse of the frame number or the measurement time and the brightness of the displayed stress generation site is displayed on the display 60 together with the images Pt. This makes it possible to more easily grasp the transition of the stress generation site.

In the above description, each stress generation site is displayed such that the brightness of the stress generation site be higher as the frame number is larger, but each stress generation site may be displayed such that the brightness is lower as the frame number is larger.

### Modification 2

In order to distinguish each stress generation site detected for each of the frames F1 to Fm, each stress generation site may be displayed with different saturation. In this Modification 2, the stress generation sites are displayed such that the higher the frame number, the higher the saturation of the stress generation site. Such a display method also makes it possible to easily grasp the behavior of the stress generation sites on one image.

FIG. 9 is a diagram for explaining a display method when displaying the measurement result of one measurement set on the display 60 in the stress measurement device 100 according to Modification 2. FIG. 9 also corresponds to FIG. 6 described in Embodiment 1.

Referring to FIG. 9, in this Modification 2, the detected stress generation sites are displayed with different saturation in the images P1 to Pm. Specifically, in the images P1 to Pm, the stress generation sites are displayed such that the saturation increases as the corresponding frame number increases. The controller 50 detects the stress generation site at the set ROI for each frame Fi (i=1 to m) and generates the images Pi indicating the stress generation site in the ROI with predetermined saturation according to the frame number such that the saturation increases as the frame number increases.

Also in this Modification 2, the image Pt acquired by superimposing the images P1 to Pm is displayed on the display 60. In the image Pt, the stress generation site corresponding to the frame Fi (i=1 to m) is displayed with predetermined saturation corresponding to the frame number such that the saturation increases as the frame number increases. Therefore, the behavior (temporal change in the position) of the stress generation sites in one measurement set can be easily grasped from one image Pt displayed on the display 60.

Also in this Modification 2, it is preferable that an index indicating the relation between the frame number or the elapse of the measurement time and the saturation of the displayed stress generation site be displayed on the display 60 together with the image Pt. This makes it possible to more easily grasp the transition of the stress generation site.

In the above description, each stress generation site is displayed such that the saturation of the stress generation site increases as the frame number increases, but each stress generation site may be displayed such that the saturation of the stress generation site decreases as the frame number increases.

In addition, although not shown in particular, the hue or the like of the stress generation site may be changed for each frame, instead of the brightness or the saturation. Also in this instance, it is preferable that an index indicating the relation between the frame number of the elapse of the measurement time and the hue or the like of the displayed stress generation site be displayed on the display 60 together with the images Pt.

### Embodiment 2

In Embodiment 2, in addition to the behavior (spatial and temporal change) of the stress generation site, the change in the magnitude of the stress generated is also displayed on one image.

The entire configuration of the stress measurement device 100 according to Embodiment 2 is the same as the configuration shown in FIG. 1 to FIG. 3. Also in this Embodiment 2, the processing of the stress measurement is executed according to the flowchart shown in FIG. 4.

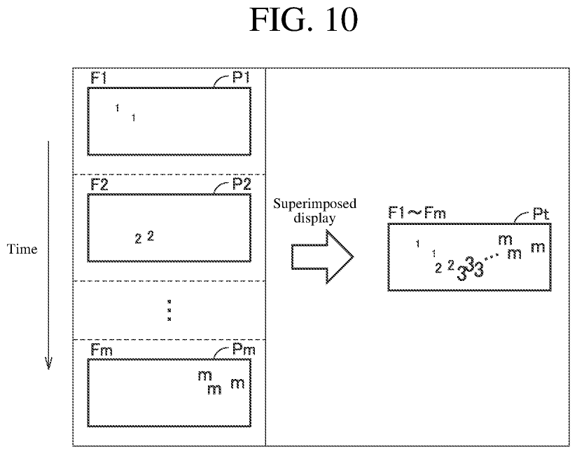

FIG. 10 is a diagram for explaining a display method when displaying the measurement result of one measurement set on the display 60 in the stress measurement device 100 according to Embodiment 2. FIG. 10 also corresponds to FIG. 6 described in Embodiment 1.

Referring to FIG. 10, even in this Embodiment 2, the controller 50 detects the stress generation site according to the luminescence distribution of the stress luminescent material 2 in each of the frames F1 to Fm. Here, in Embodiment 1, an area where the luminescence intensity is higher than a threshold value is detected as the stress generation site, and the numeric character of the frame number corresponding to the detected stress generation site is simply arranged. However, in this Embodiment 2, the size of the number to be displayed is adjusted according to the magnitude of the luminescence intensity. Specifically, in each image Pi (i=1 to m), the higher the luminescence intensity of the detected stress generation site, the larger the displayed numeric character “i” is displayed. In the case of FIG. 10, it can be seen from the sizes of the numeric characters “i” that the stress is larger at the time of the imaging of the frame F3 or the frame Fm.

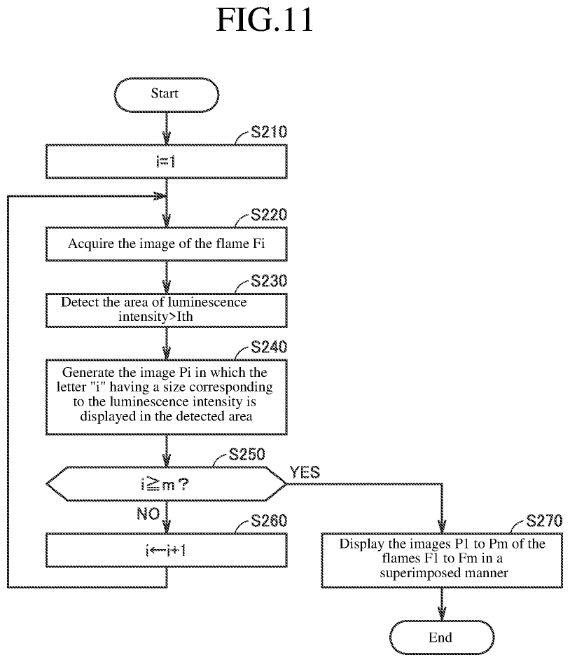

FIG. 11 is a flowchart showing the procedures of the image processing and the image displaying executed by the controller 50 in Embodiment 2. This flowchart shows in detail the processing executed in Steps S50 and S60 of FIG. 4 in Embodiment 2.

Referring to FIG. 11, the processing of Steps S210 to S230, S250 to S270 is the same as the processing of Steps S110 to S130, S150 to S170 shown in FIG. 7.

Then, in this Embodiment 2, when an area (stress generation site) in which the luminescence intensity is higher than a threshold Ith in the ROI is detected in the acquired image in Step S230, the controller 50 generates an image Pi indicating the stress generation site in the frame i by arranging the numeric character “i” having the magnitude corresponding to the luminescence intensity in the area (stress generation site) detected in Step S230 for the set ROI (Step S240). That is, the area in the image Pi where the character “i” is displayed indicates the stress generation site at the time when the frame Fi is imaged, and the size of the character “i” indicates the magnitude of the generated stress.

When it is determined in Step S250 that the variable i has reached the frame number m (YES in Step S250), the controller 50 displays an image Pt acquired by superimposing the images P1 to Pm respectively corresponding to the frames F1 to Fm generated in Step S240 on the display 60 (Step S270).

According to this Embodiment 2, since the size of the character “i” indicates the magnitude of the stress generated, in addition to the behavior of stress generation sites (spatial and temporal change), the change in the magnitude of the generated stress can also be displayed on one image.

### Embodiment 3

Each embodiment and each modification described above relate to the behavior (space and temporal change) of the stress generation site at one measurement set. However, Embodiment 3 relates to the behavior (spatial and temporal change) of the stress generation site at the time common to each measurement set when the bending test is repeated.

In this Embodiment 3, the time at which the stress generation site is observed in one measurement set is specified. In particular, any time within the measurement time Tm of a measurement set can be specified by the user from the operation unit 70. For example, the user can specify the time corresponding to the timing at which the stress on the sample 1 becomes maximum in one test. By identifying the time within one measurement set by the user, the same time is identified for the remaining measurement sets. That is, the specified time is a time common to the measurement sets.

When the bending test is repeatedly performed, the behavior (spatial and temporal change) of the stress generation site according to the number of tests can be observed by observing the stress generation site at a specified time common to each measurement set acquired sequentially. However, it may take time and labor to display a plurality of images captured for each measurement set one by one on the display 60 in chronological order and observe the images.

Therefore, in the stress measurement device 100 according to Embodiment 3, each stress generation site detected for each of the plurality of images acquired by being captured at a particular time of each measurement set is displayed on the display 60 in a superimposed manner on one image in mutually different display modes. With this, when the bending test is repeatedly performed, the behavior (spatial and temporal change) of the stress generation site according to the number of tests can be easily grasped.

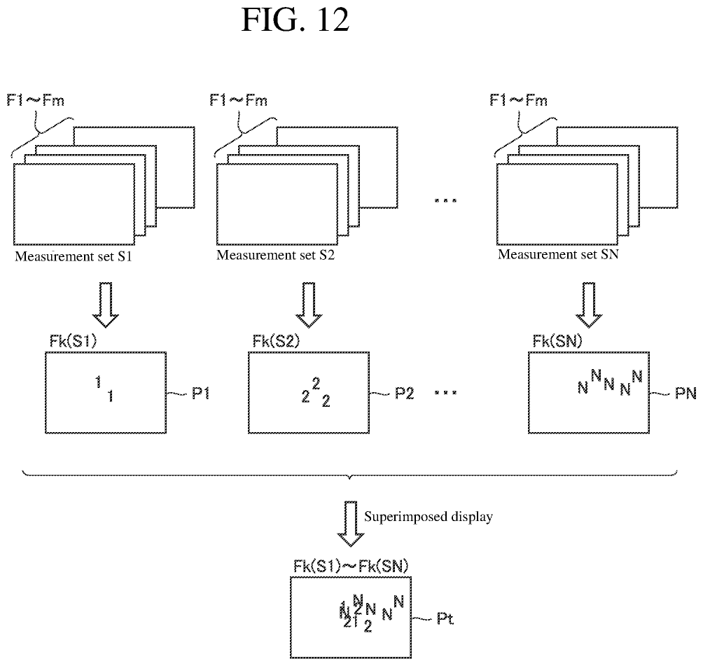

FIG. 12 is a diagram for explaining a method of displaying a measurement result at a specified time for each measurement set on the display 60 in the stress measurement device 100 according to Embodiment 3. Note that in this case, by executing the bending test N times, a total of N times of repetitive stresses are applied to the sample 1, thereby acquiring a total of N pieces of measurement sets S1 to SN.

Referring to FIG. 12, the controller 50 extracts an image of the luminescence intensity distribution of the frame Fk corresponding to a particular time from the images of m luminescence intensity distributions corresponding to the frames Fl to Fm for each of the measurement sets S1 to SN. Then, the controller 50 detects the stress generation site according to the luminescence distribution of the stress luminescent material 2 for the image of the extracted luminescence intensity distribution. Note that also in this Embodiment 3, the area where the luminescence intensity is higher than a threshold value is detected as the stress generation site.

The images P1 to PN show a stress generation site at a particular time of each measurement set S1 to SN for a given ROI in the captured image by the camera 40. In this embodiment, in each of the images P1 to PN, the number of the corresponding measurement set is arranged in the detected stress generation site.

Specifically, the controller 50 detects the stress generation site in the set ROI for each flame Fk (Sj) (j=1 to N) at a specified time of the measurement set S1 to SN and place the character “j” of the number of the frame in the detected stress generation site to thereby generate an image Pj indicating the stress generation site in the ROI. In this Embodiment 3, in each image Pj, the size of the character “j” displayed in the stress generation site is the same. Therefore, the larger the region of stress generation site, the larger the number of the character “j” to be displayed.

Then, in the stress measurement device 100 according to Embodiment 3, the image Pt acquired by superimposing the images P1 to PN is displayed on the display 60. In the image Pt, the stress generation site corresponding to the frame Fk (Sj) (j=1 to N) is displayed by the character “j”. Therefore, when the bending test is repeatedly performed, the behavior (temporal change of the position) of the stress generation site at a particular time of the test can be easily grasped from the one image Pt displayed on the display 60.

The entire configuration of the stress measurement device 100 according to Embodiment 3 is the same as the configuration shown in FIG. 1 to FIG. 3. Also in this Embodiment 3, the processing of the stress measurement is executed according to the flowchart shown in FIG. 4.

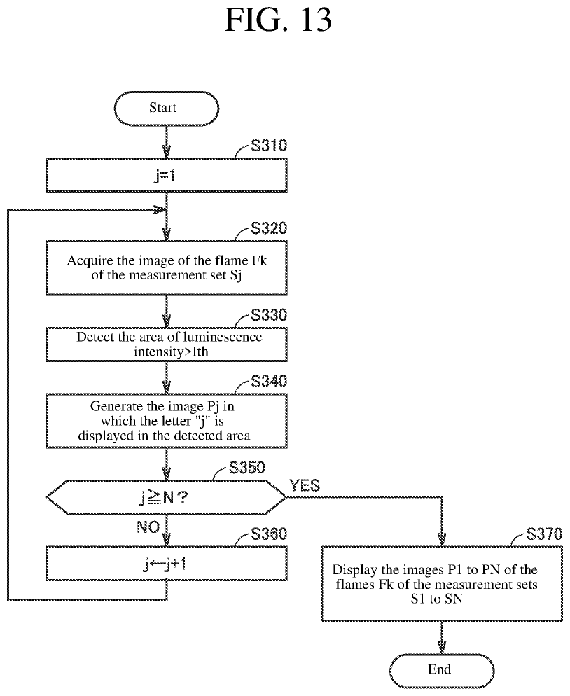

FIG. 13 is a flowchart showing the procedures of the image processing and the image displaying executed by the controller 50 in Embodiment 3. This flowchart shows in detail the processing executed in Steps S50 and S60 of FIG. 4 in Embodiment 3.

Referring to FIG. 13, the controller 50 first sets 1 to the variable j (Step S310) and acquires the image of the frame Fk (Sj) of the measurement set Sj (Step S320). Note that as described above, the frame Fk (Sj) is a frame corresponding to the time specified by the user from the operation unit 70 within the measurement time Tm of the measurement set Sj.

Next, the controller 50 detects an area (stress generation site) in which the luminescence intensity is higher than a threshold Ith the acquired image within the set ROI (Step S330). Then, the controller 50 arranges the character “j” in the area (stress generation site) detected in Step S330 with respect to the set ROI to generate the image Pj indicating the stress generation site at the specified time of the measurement set Sj (Step S340). That is, the area in which the character “j” is displayed in the image Pj indicates the stress generation site at the time when the frame Fk (Sj) is imaged.

Next, the controller 50 determines whether or not the variable j is equal to or larger than the measurement set number N (Step S350). When the variable j is smaller than the measurement set number N (NO in Step S350), the controller 50 increments the variable j by 1 (Step S360) and returns the processing to Step S320. That is, the processing of Steps S320 to 5340 is repeatedly executed until the variable j reaches the measurement set number N.

When it is determined in Step S350 that the variable j has reached the measurement set number N (YES in Step S350), the controller 50 displays the image Pt acquired by superimposing the images P1 to PN corresponding to the measurement sets S1 to SN generated in Step S340 on the display 60 (Step S370).

As described above, in Embodiment 3, in the stress measurement of the repetition with respect to the sample 1, the stress generation site is detected for each image captured by the camera 40 at a particular time in one measurement, and the detected stress generation site is displayed on one image (image Pt) in a superimposed manner in mutually different display modes for each measurement set. Therefore, according to Embodiment 3, the behavior of the stress generation site at a particular time within the measurement time of each measurement can be easily grasped in the repetitive stress measurements to the sample 1.

### Modification 3 of Embodiment

For Embodiment 3, similarly to Modification 1 described above, each stress generation site may be displayed with different brightness in order to distinguish the stress generation sites of the measurement sets S1 to SN in the image Pt displayed on the display 60. For example, the greater the number of the measurement set, the higher (or lower) the stress generation site may be displayed.

Further, similarly to the above-described Modification 2, in order to distinguish the stress generation sites of the measurement sets S1 to SN in the image Pt displayed on the display 60, each stress generation site may be displayed with saturations that differ from each other. For example, the higher the measurement set number, the higher (or lower) the saturation of the stress generation site.

Further, in the same manner as in the above-described Embodiment 2, for the stress generation site at the specified time in each measurement set S1 to SN, in addition to the behavior (spatial and temporal change) of the stress generation site, the changes in the magnitude of stresses generated may also be displayed on one image

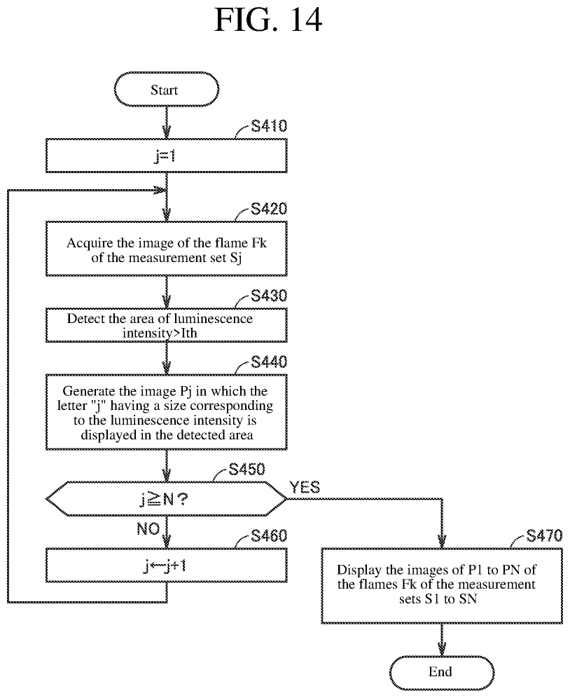

FIG. 14 is a flowchart showing procedures of the image processing and the image displaying executed by the controller 50 in the above-described modification of Embodiment 3. This flowchart shows in detail the processing executed in Steps S50 and S60 of FIG. 4 in the modification.

Referring to FIG. 14, the processing of Steps S410 to S430, S450 to S470 is the same as the processing of Steps S310 to S330, S350 to S370 shown in FIG. 13.

In this modification, when an area (stress generation site) in which the luminescence intensity is higher than a threshold Ith in the ROI is detected in the acquired image in Step S430, the controller 50 arranges a character “j” having a size corresponding to the luminescence intensity in the area (stress generation site) detected in Step S430 for the set ROI to thereby generate an image Pj indicating the stress generation site in the frame Fk (Sj) (Step S440). That is, the area in the image Pj where the character “j” is displayed indicates the stress generation site at the time when the frame Fk (Sj) is imaged, and the size of the character “j” indicates the magnitude of the generated stress.

When it is determined in Step S450 that the variable j has reached the measurement set number N (YES in Step S450), the controller 50 displays an image Pt acquired by superimposing the images P1 to PN corresponding to the measurement sets S1 to SN generated in Step S440 on the display 60 (Step S470).

This modification also shows the size of the letter “j” indicates the magnitude of the stress. Therefore, for the stress generation site at a particular time in the measurement sets S1 to SN, in addition to the behavior (spatial and temporal change) of the stress generation site, the change in the magnitude of the stress generated can also be displayed on one image.

### [Aspects]

It would be understood by those skilled in the art that the plurality of exemplary embodiments described above and modifications thereof are specific examples of the following aspects.

### (Item 1)

A stress measurement device according to one aspect of the present invention is a stress measurement device for measuring a stress occurring in a sample by detecting luminescence of a stress luminescent material arranged on a surface of the sample.

The stress measurement device includes:

an imaging device configured to image light emitted by the stress luminescent material;

a processor configured to process the image captured by the imaging device; and

a display configured to display the image processed by the processor.

The processor is configured to:

detect a stress generation site according to a luminescence distribution of the stress luminescent material, for each of a plurality of time-series images captured by the imaging device; and

control the display such that each stress generation site detected for each of the plurality of images is displayed on one image in a superimposed manner in mutually different display modes.

According to this stress measurement device, since each stress generation site detected for each captured time-series image is displayed on one image in a superimposed manner in mutually different display modes, the behavior of the stress generation site in the sample can be easily grasped.

### (Item 2)

In the stress measurement device as recited in the above-described item 1,

the processor is configured to:

detect the stress generation site for each of a plurality of images sequentially captured by the imaging device in one stress measurement to the sample; and

control the display such that each stress generation site detected for each of the plurality of images is displayed on one image in mutually different display modes.

According to this stress measurement device, it is possible to easily grasp the behavior of the stress generation site in one stress measurement to the sample.

### (Item 3)

In the stress measurement device as recited in the above-described item 1,

the processor is configured to:

detect the stress generation site for each of the plurality of images acquired by being captured by the imaging device at a particular time within a measurement time in each measurement, in repeated stress measurements of the sample; and

control the display such that each stress generation site detected for each of the plurality of images is displayed on one image in a superimposed manner in mutually different display modes.

According to stress measurement device, the behavior of the stress generation site at a particular time within the measurement time of the respective measurements can be easily grasped in the stress measurement of the repetition to the sample.

### (Item 4)

In the stress measurement device as recited in any one of the above-described items 1 to 3,

the processor detects an area where luminescence intensity of the stress luminescent material exceeds a threshold as the stress generation site.

According to this stress measurement device, it is possible to extract a stress generation site worthy of verification and easily observe the behavior on one image.

### (Item 5)

In the stress measurement device as recited in any one of the above-described items 1 to 4,

the processor controls the display such that each stress generation site detected for each image is displayed on one image in a superimposed manner with mutually different symbols.

According to this stress measurement device, the transition of the respective stress generation site displayed on one image can be easily grasped.

### (Item 6)

In the stress measurement device as recited in the above-described item 5, the processor further controls the display such that each stress generation site detected for each image is displayed in mutually different display modes depending on luminescence intensity.

According to this stress measurement device, in addition to the behavior of the stress generation site, the change in the magnitude of the generated stresses can also be easily grasped on one image.

### (Item 7)

In the stress measurement device as recited in the above-described item 6, the processor controls the display such that a size of the symbol becomes larger as the stress generation site is higher in the luminescence intensity.

According to the stress measurement device, in addition to the behavior of the stress generation site, the relative magnitude of the stress generated can also be easily grasped on one image.

### (Item 8)

In the stress measurement device as recited in any one of the above-described items 1 to 6, the processor controls the display such that each stress generation site detected for each image is displayed on one image in a superimposed manner at mutually different brightness levels.

### (Item 9)

In the stress measurement device as recited in any one of the above-described items 1 to 6, the processor controls the display such that each stress generation site detected for each image is displayed on one image in a superimposed manner with different saturations.

With these configurations as well, the transition of each stress generation site displayed on one image can be easily grasped.

Embodiments disclosed herein are to be considered in all respects as illustrative and not restrictive. The scope of the present invention is indicated by the claims rather than by the descriptions of the embodiments described above, and it is intended to include all modifications within the meanings and ranges equivalent to those of the claims.

### DESCRIPTION OF SYMBOLS

1: Sample
2: Stress luminescent material
10: Holder
11: First mounting plate
11a, 12a: Main surface
12: Second mounting plate
13: Drive shaft
15: Housing
20: First driver
31: Light source
32: Third driver
40: Camera
42: Second driver
50: Controller
60: Display
61: Stress control unit
62: Light source control unit
63: Imaging control unit
64: Measurement control unit
65: Data acquisition unit
66: Data processing unit
70: Operation unit
100: Stress measurement device
501: Processor
502: Memory
503: Input/output I/F
504: Communication I/F

1. A stress measurement device for measuring a stress occurring in a sample by detecting luminescence of a stress luminescent material arranged on a surface of the sample,
the stress measurement device comprising:
an imaging device configured to image light emitted by the stress luminescent material;
a processor configured to process the image captured by the imaging device; and
a display configured to display the image processed by the processor.
wherein the processor is configured to:
detect a stress generation site according to a luminescence distribution of the stress luminescent material, for each of a plurality of time-series images captured by the imaging device; and
control the display such that each stress generation site detected for each of the plurality of images is displayed on one image in a superimposed manner in mutually different display modes.

2. The stress measurement device as recited in claim 1,
wherein the processor is configured to:
detect the stress generation site for each of a plurality of images sequentially captured by the imaging device in one stress measurement to the sample; and
control the display such that each stress generation site detected for each of the plurality of images is displayed on one image in a superimposed manner in mutually different display modes.

3. The stress measurement device as recited in claim 1,
wherein the processor is configured to:
detect the stress generation site for each of the plurality of images acquired by being captured by the imaging device at a particular time within a measurement time in each measurement, in repeated stress measurements of the sample; and
control the display such that each stress generation site detected for each of the plurality of images is displayed on one image in a superimposed manner in mutually different display modes.

4. The stress measurement device as recited in claim 1,
wherein the processor detects an area where luminescence intensity of the stress luminescent material exceeds a threshold as the stress generation site.

5. The stress measurement device as recited in claim 1,
wherein the processor controls the display such that each stress generation site detected for each image is displayed on one image in a superimposed manner with mutually different symbols.

6. The stress measurement device as recited in claim 5,
wherein the processor further controls the display such that each stress generation site detected for each image is displayed in mutually different display modes depending on luminescence intensity.

7. The stress measurement device as recited in claim 6,
wherein the processor controls the display such that a size of the symbol becomes larger as the stress generation site is higher in the luminescence intensity.

8. The stress measurement device as recited in claim 1,
wherein the processor controls the display such that each stress generation site detected for each image is displayed on one image in a superimposed manner at mutually different brightness levels.

9. The stress measurement device as recited in claim 1,
wherein the processor controls the display such that each stress generation site detected for each image is displayed on one image in a superimposed manner with mutually different saturations.
